(19) United States
(12) Patent Application Publication
(10) Pub. No.: US 2007/0225990 A1
(43) Pub. Date: Sep. 27, 2007

(54) Custody calculation system

(76) Inventor: Catherine MacWillie, San Dimas, PA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/386,070

(22) Filed: Mar. 21, 2006

(51) Int. Cl. G06Q 10/00; G06Q 30/00; H04L 9/00

(52) U.S. Cl. 705/1; 705/80

(57) ABSTRACT

A method creating a custody order and custody calculation comprising: inputting general background information relating to the parent and child for whom custody is to be shared; calculating a custody percentage between the respective parents based upon a plurality of criteria; generating a Court Order relating to custody; and generating a custody calendar for the parents.

### CROSS-REFERENCE TO RELATED APPLICATIONS

The present application claims the priority of U.S. Ser. No. 60/549,676, which is incorporated by reference herein in its entirety.

### FIELD OF THE INVENTION

The present invention is directed to a method and apparatus to perform custody calculations and related computations as well as for generating Court Orders related to child custody and divorce.

### BACKGROUND OF THE INVENTION

One of the most difficult and painful issues which divorcing people face is the handling and management of children, and issues related to child custody. Previously, there has been no easy way for the parties, their lawyers, or court administrators to perform custody calculations. Typically, calculations historically have been performed by hand and are often not accurate. The crude calculations are then written into the Order and presented to the Court. It is often difficult for non-lawyers to understand Court Orders and frequently important matters related to child are omitted from Orders. Because of the complexities of these Orders, there are frequently scheduling anomalies which go unrecognized, often to the detriment to the child.

The patent literature includes a number of prior art references which relate to determining allocations as well as the generation of family relations Orders. U.S. Pat. No. 5,983,205 discloses two methods, “Adjusted Winner (AW)” and “Proportional Allocation (PA),” which are provided for the fair division of a collection of items, which could be either real goods or issues in a dispute, between two claimants (parties). The methods can be implemented as a digital computer software program. In both methods, the parties are each given 100 points and then bid on each item using their points. Under the AW method, which is applicable to indivisible items, each party is initially allocated those goods, or wins on those issues, for which it bids the higher number of points. Then the goods or issues are reassigned, or resolved differently, to achieve equality of points based on the quotients of the parties' bids. Under PA, each good or issue is divided according to a ratio based on both parties' bids for that good or issue.

U.S. Patent No. 20050125442 discloses a computerized systems and methods for producing domestic relations orders (DRO's). In one embodiment, a computerized system for producing DROs includes a receiver for receiving information relating to a domestic relations order, a rules engine for authenticating the received information, and a document assembler for automatically incorporating the received information into a domestic relations order.

U.S. Patent No. 20040172279 discloses a method, system, and computer-readable signal containing instructions for facilitating complex relationship-based interactions among users of a community, such community corresponding to a broken family. A database is communicably coupled to a full-time, public network, wherein the database includes functionalities and is configured to make said functionalities accessible via the full-time, public network. Data is recorded in the database defining the community and associating a manager with the community, wherein the manager is a user of the community. The manager can invite others to join the community in order to become additional users of the community. The manager can establish common approval items with regard to which two specific users must agree in order to make a decision. One or more users of the community can share information with one or more other users of the community.

Heretofore, there has not been a system which generates custody percentages, generates Orders and produces calendars.

### SUMMARY OF THE INVENTION

It is an aspect of the present invention to provide an improved way to effectuate custody calculations. In a most preferred embodiment, the inventions is a method creating a custody order and calculation comprising: inputting general background information relating to the parent and child for whom custody is to be shared; calculating a custody percentage between the respective parents based upon a plurality of criteria including scheduling anomolies; generating a Court Order setting forth the terms of the custody between the parents; and generating a custody calendar for the parents.

In a further embodiment, the invention is a method creating a custody order and custody calculation comprising: inputting general background information relating to the parent and child for whom custody is to be shared; calculating a custody percentage between the respective parents based upon a plurality of criteria; generating a Court Order relating to custody; and generating a custody calendar for the parents.

In still a further embodiment, the inventions is a method creating a custody order and custody calculation comprising: inputting general background information relating to the parent and child for whom custody is to be shared; calculating a custody percentage between the respective parents based upon a plurality of criteria including scheduling anomalies; generating a Court Order relating to custody including the provision of communication protocols between the parents; and generating a custody calendar for the parents and court.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

The present invention is now described with reference to the attached FIGS. 1-3m. As can be seen, these Figures illustrate a comprehensive set of Figures which illustrate the user screens of the present invention.

FIGS. 1-3 are block diagrams of the operation of the present invention.

FIG. 4 is a block diagram of the present invention.

FIGS. 5a to 5k are screen shots of the calculation checklist.

FIG. 6 illustrates the custody calendar.

FIG. 7a to 7y illustrate the screens for generating a Court Order.

### DETAILED DESCRIPTION OF THE PRESENT INVENTION

The present invention is directed to a system for generating custody orders and calculations. While the present invention is being described in the context of a system using a personal computer, the manner of the end user device is not critical to the present invention. The present invention may be used with any system that connects to the Internet or uses other IP transport methods. The end user device can comprise any end user device which can connect to a network such as a wireless device, palm pilot, PDA, end user work station or hand-held device.

In a most preferred embodiment, the present invention is directed to a system for facilitating the creation of custody calculations and Orders. Over the past twenty (20) years, personal computers have become relatively powerful and inexpensive and have gained widespread use in a significant number of homes and businesses. With a modem, personal computers can communicate with other computers through communication networks and access many resources on the so-called “Information Super Highway.” Companies such as America Online, CompuServe and Prodigy, which traditionally provided so-called “content” over proprietary networks, have begun to provide access by personal computer users to an expansive international network of computer networks known as the Internet.

As is well known by those skilled in the art, the World Wide Web is a graphical sub-network of the Internet. With common “Web Browser” software such as Mosaic, Netscape Navigator, or Microsoft Explorer, end users may easily access Internet information and services on the World Wide Web. A web browser handles the functions of locating and targeting information on the Internet and displaying the information provided by the Web Server. The World Wide Web utilizes technology called “Hyper-Text” to organize, search and present information on the Internet. Using a web browser, the end user can select a word (“Hyper-Text word”) from a view document and be linked to another document featuring information related to the word.

The present invention is broadly directed to a computer network for creating Custody Orders and schedules. The present invention is designed, in one embodiment, to be utilized on the World Wide Web or Internet, although the present invention is equally applicable to other network environments. As noted above, the present invention is similarly related to user interfaces which are not computers such as palm pilots, wireless and cellular devices.

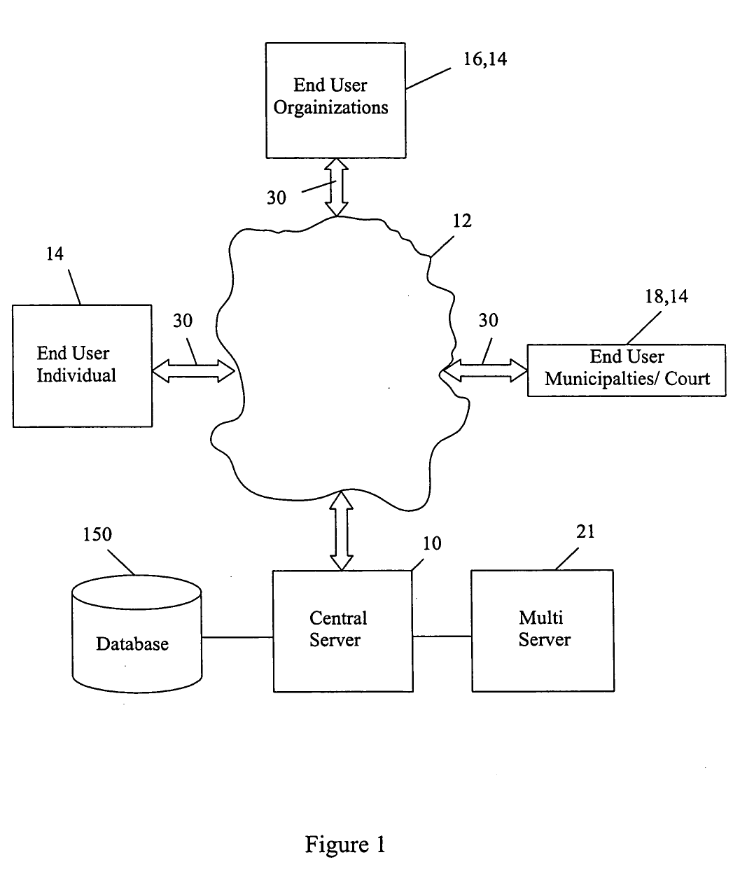

Referring to FIG. 1, a most preferred embodiment of the present invention is disclosed and shown. The most preferred embodiment comprises a central computer server 10 connected by a computer network 12 to remote end user stations 14. The central server connects to a database 150. In a preferred embodiment, end user stations 14 comprise a plurality of end users. End users 16, 18 are defined herein as individuals such as a divorcing couple linked to the system who may wish to use the system to create a Custody Order. End users may also comprise court administrative personnel as well as state agencies.

For purposes of this disclosure, an end user is defined as an individual who seeks to establish and set up a calendar. Users 16, 18 are linked with the central computer server 10 via a transport medium 30. End users 16, 18 will typically comprise sellers and buyers who, in a most preferred embodiment, will be linked via a global computer network 12 such as the Internet or Worldwide web, but other embodiments including LANs, WANs and Intranets, fulfill the spirit and scope of the present invention.

The end user devices 16, 18 will typically comprise any device that connects to the system via the Internet or other IP transport methods and includes, but is not limited to, such devices as televisions, computers, hand-held devices, cellular phones, land based telephones, wireless electronic devices and any device which uses a transport medium 30. Non-limiting examples of a transport medium 30 applicable for use in the present invention comprise any backbone or link such as an ATM link, FDDI link, satellite link, cable, cellular, twisted pair, fiber optic, broadcast wireless network, the internet, the world wide web, local area network (LAN), wide area network (WAN), or any other kind of intranet environment such a standard Ethernet link. In such alternative cases, the clients will communicate with the system using protocols appropriate to the network to which that client is attached. All such embodiments and equivalents thereof are intended to be within the scope of the present invention.

Referring again to FIG. 1, the present invention may comprise a multi-server 21 environment which comprises a computer system in accordance with the present invention that allows the multiple end users 16, 18 to communicate with the system and system clients. Through communication link and transport medium 30, end user keyers 16, 18 will receive data entries which must be correctly identified and confirmed and who are linked to the central server 12, preferably by a customizable interface to be described in greater detail below.

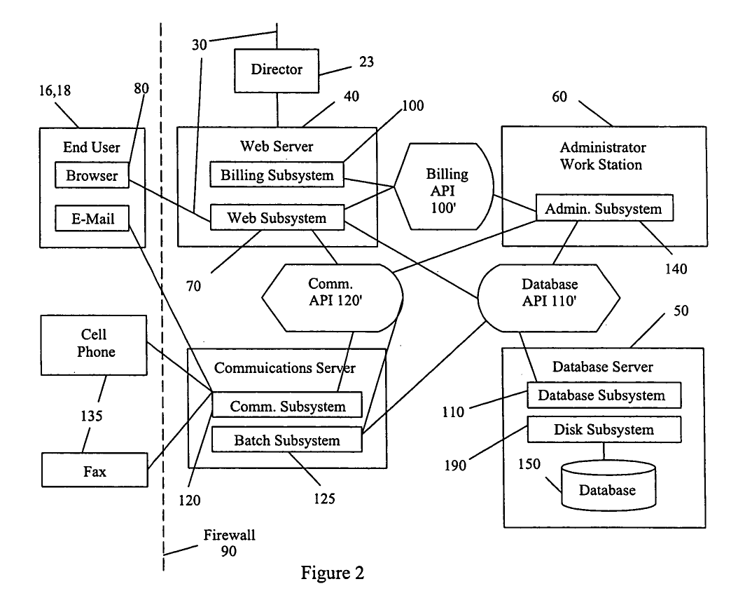

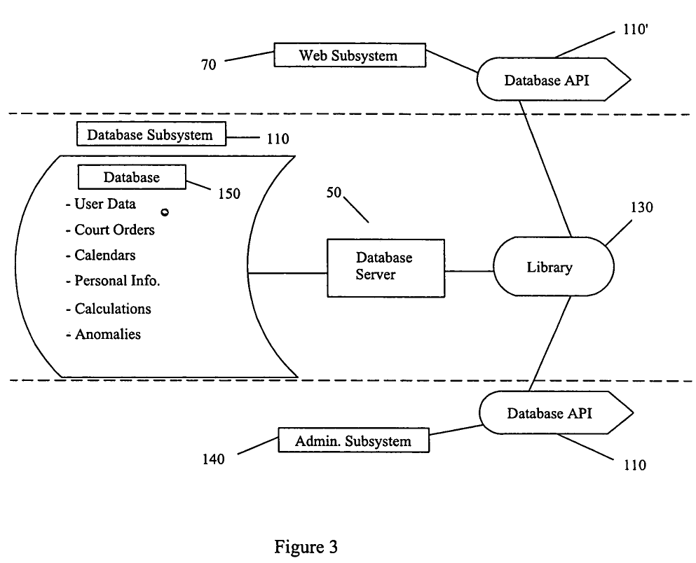

Referring to FIGS. 2 and 3, the central server and database systems of the present invention are now shown and described in greater detail. A local director 23 routes signals through the system to the various servers, to be described below, and to and through transport medium 30 to end users 16, 18. The system preferably includes two primary servers, a web server 40 and a database server 50 which may operate using such database platforms as SQL server or Oracle. Hence, in one embodiment the SQL server may run SQL server database management software from Microsoft Corporation. Alternatively, the server can further comprise an Oracle database server. The system further includes an administrative work station 60 or system which provides the administrative capabilities and monitoring for the system under the control of an administrative subsystem 140. The administrative work station 60 allows administrators or other operators to perform routine operations which affect the entire system. Such operations include, but are not limited to, administering the accounts of end users 16, 18 monitoring the traffic through the system, the tabulating of user balances and ratings, printing reports, the updating of end user keyers, the performing of backups and maintaining the programs that comprise the overall system.

A web subsystem 70 is responsible for all interactions with a web browser 80 in the end user devices 16, 18 and serves as the end user interface to the system. All interactions between the end user devices 16, 18 and the database subsystem occur through the web subsystem 70. Internet Information Server 200 (IIS) by Microsoft Corporation is an exemplary web server software system 70 in accordance with the present invention, although the present invention is in no way limited to this system. The expression of the user interface presented to end user keyers 16, 18 in their client devices may be implemented as HTML or other high level computer language or technology, and may be displayed in a standard web browser.

All systems listed above are preferably communicated via an Ethernet 100 base T network and a switching hub. In addition, a second isolated network segment will preferably exist between the web server 40 and the external communications hardware (e.g. internet router). Such a system will keep external traffic isolated from the internal network, as well as provide a dedicated connection between the web server 40 and the Internet for maximum throughput. The systems will have an initial configuration of random access memory for the web server 40 and preferably at least 128 megabits for the database server 50, both having the capability to expand.

The web server 40 is the point of entry to the entire system. The system determines the identity of the user 16, 18 and makes appropriate decisions while serving web pages to the end user 16, 18. The web server 40 sends HTML or other high level computer language to the end user work stations 16, 18, validates passwords, sends logging and transaction information to the database server 50, and performs logical operations, thus behaving as a transactional server.

As noted above, in one embodiment, the server operating system may be a Windows NT server, a multi-platform operating system provided by Microsoft Corporation. The Sun Microsystems Solaris is an alternative embodiment. The server typically includes IIS, which is a completely integrated Internet application platform. IIS includes a high-performance web server, an application development environment, integrated full-text searching, multi-media streaming and site management tools. The security infrastructure is integrated within the server, thus enabling an easy-to-maintain and highly-secure web development and deployment environment.

The operators of the system may create, delete and update account information by utilizing the administrative subsystem 140 in administration work station 60. A billing subsystem 100 is used for crediting and debiting end user keyer accounts. As will be discussed below, end user 16, 18 will typically receive remuneration of some manner for participating in the system including cash or other premiums.

Database 110, communication 120 and billing 100 subsystems thus execute essential services for the other parts of the system, and will therefore have well-defined application program interfaces (API) 110′, 120′, 100′, as is well recognized by those with skill in the art. The system will preferably be protected for the Internet by a “firewall” 90 which is a safety precaution, and important with respect to the present invention due to the sensitive and confidential nature of the information in the database. As will be discussed below, firewall 90 plays an important and critical role in the present invention because of the confidentiality of the data associated with some applications of the present invention.

In a preferred embodiment, the database subsystem 110 stores all pertinent information pertaining to user accounts, administrator accounts, payment and remuneration parameters, as well as general dynamic system information. All interactions with the database subsystem 110 are performed through a database API 110′ which may define the interface to a library of stored procedures 130. These are used to implement high-level database functions and to shield the details of the database implementation from the other subsystems. The database subsystem 110 is preferably implemented using database server 50.

The administration subsystem 140 provides an interface for operators and managers of the system to modify the database, print reports, view system data and log user comments and complaints. The administration subsystem 140 provides a collection of access forms, queries, reports and modules to implement the administration interface. Administrators typically will have the power within the system to force most actions. The administration subsystem 140 will interact with the communications, database and billing subsystems.

The communications subsystem 120 interfaced to a communications API 120′ will be used to email and contact end users 16, 18. End users 16, 18 may be notified by phone, fax, email or pager, or other communications devices which can be contacted by the system 135. End users 16, 18 will also have a password accessed section of a website where they can access information relevant to their activities and be provided with detailed reports.

Some portable telephones and pagers include email addresses and so may be contacted by the email system; other users have only phone numbers. Other interfaces may be utilized as the application so demands.

A batch subsystem 125 may periodically send out grouped notifications. It will access the database subsystem 110 to determine what notifications are required, and uses the communication subsystem 120 to make those notifications. A group notification may comprise a special premium offered to end user keyers 16, 18. The billing subsystem 100 will be used to verify and bill credit cards and communicate through the billing API 100′ to the administration subsystem 140, and potentially to an outside billing and verification service which could be used to perform the billing functions.

Referring to FIG. 3, the database server 50 which implements the database subsystem 110 of the present invention comprises a server that maintains all associated logging and transaction information for the system. Through the database 150 (which is backed up by a backup database for safety purposes), the database server 50, stores information related to Orders, calendars and custody calculations, maintains user account information, maintains account balances, produces and prints reports, hosts backup operations and performs statistical calculations for the entire system.

The database server 50 is preferably a dual processor computer microprocessor. Each connection to the database 150 and its associated work may be handled by a separate thread within the database server 50 process space. It is anticipated that a dual processor machine is sufficient for the type and amount of transactions that it will be performing, however if it proves insufficient, the database can be “striped” to two or more machines to distribute the server load.

In one embodiment, there will be one operator workstation 60 used for administering the system. As the need for additional workstations arises, additional operator workstations can be added by adding additional computer systems, installing the administration software and connecting them to the LAN. Operator workstation machines preferably utilize a Windows operating environment manufactured by Microsoft Corporation.

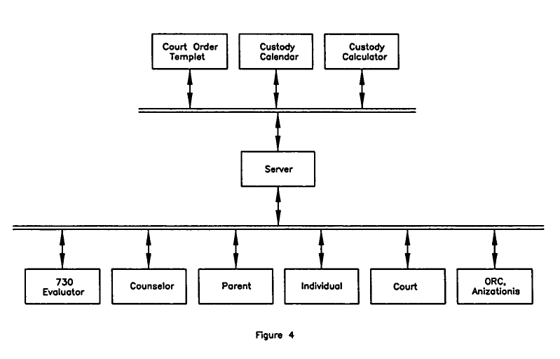

Referring to FIG. 4, a block diagram in accordance with the present invention is shown. The invention comprises a plurality of end users 18 connected to a server. The server is used in association with three software modules, a calculations checklist module 200, a Court Order module 202, and a calendar generation module 204. The system is accessible by parents, Child welfare agencies and court administration.

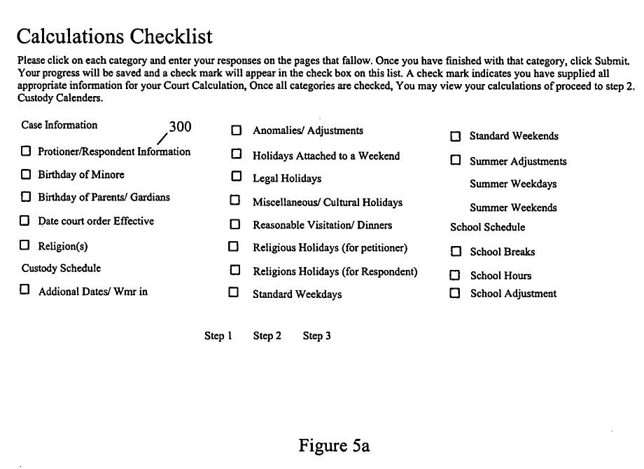

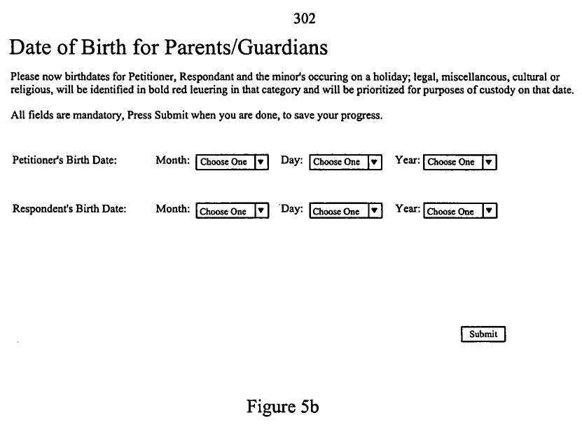

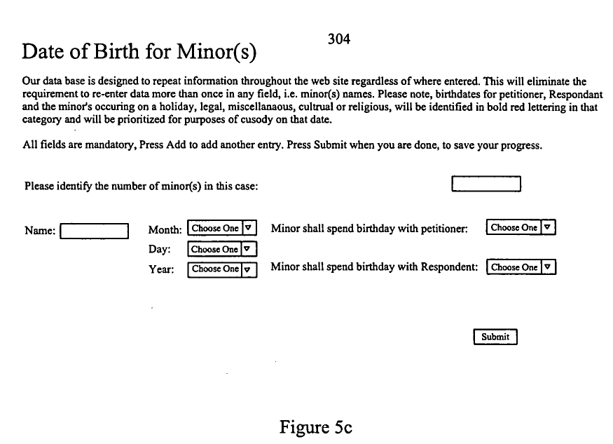

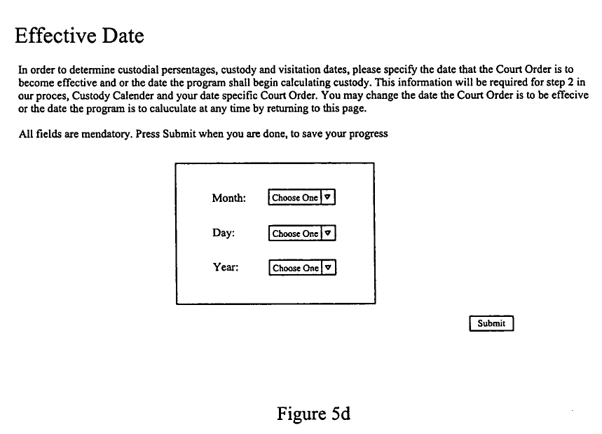

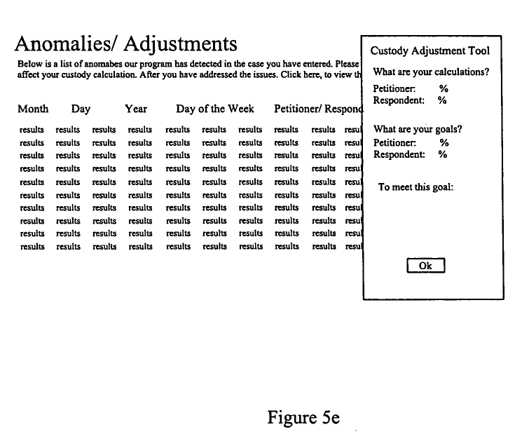

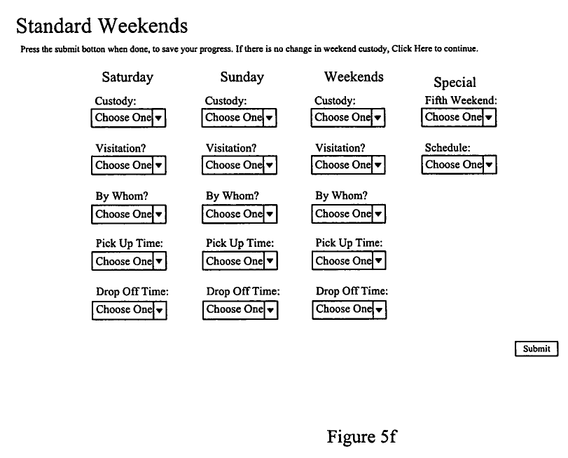

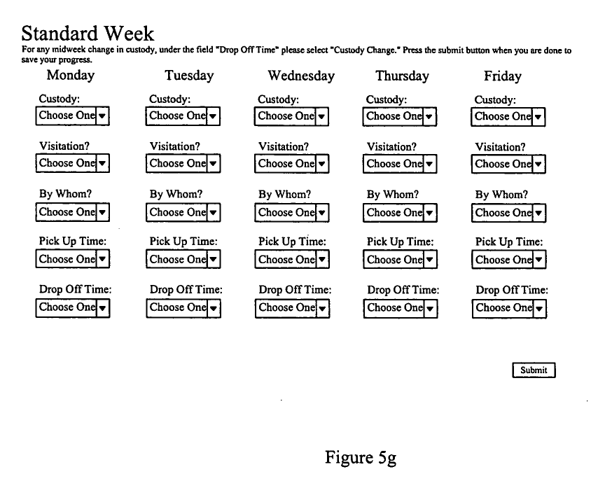

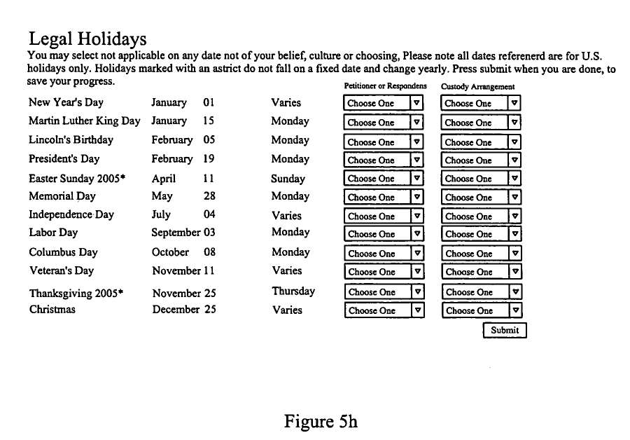

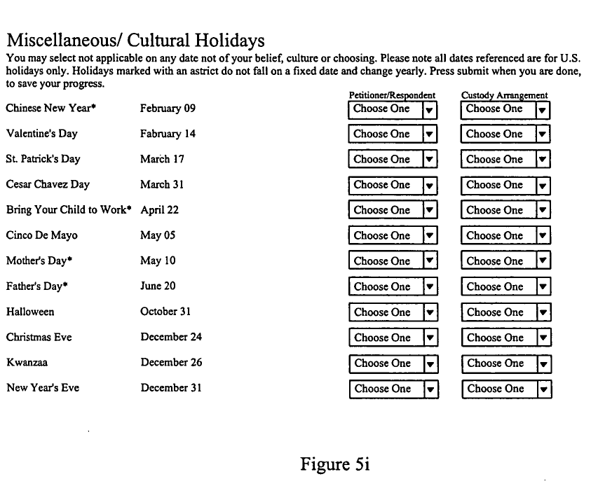

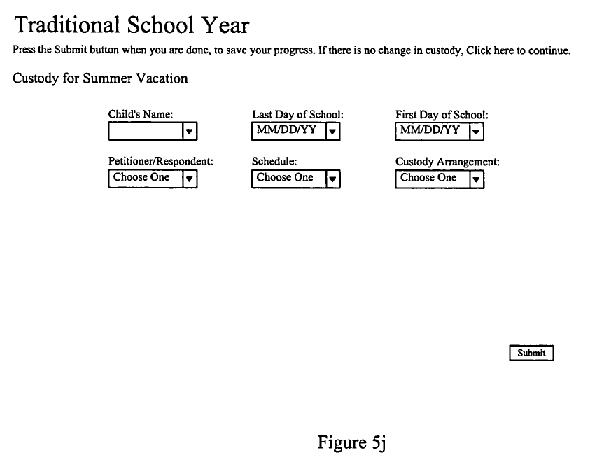

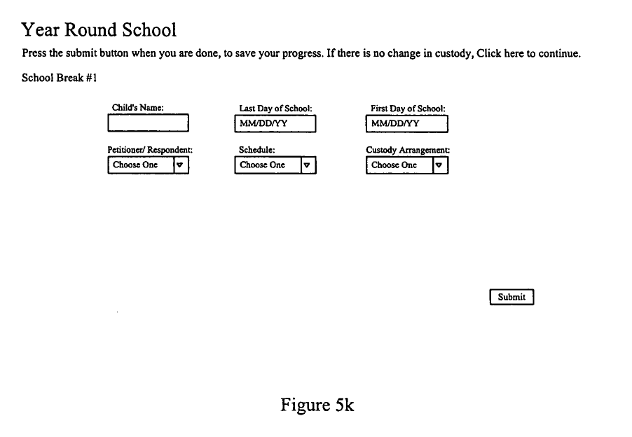

Referring now to FIGS. 5a-5k, the initial screens provide the calculations checklist module 200 are shown. These screens facilitate the input of petitioner/respondent information 300, including the birthdates of the minors, parents and guardians 302, 304. A further screen permits the input of the Order's effective dates 306. The next part of the module provides for the custody schedule including anomalies and adjustments 308, legal holidays 310, standard weekdays 312, and standard weekends 314. The system also provides for adjustments for summer holidays and school breaks such as Christmas and Easter.

An anomaly occurs when the parties, petitioner and respondent, both have legal custody of the minors on the same day. An example of that would be when the minor's birthdate falls on a legal, cultural, miscellaneous holiday, or when the minor's birthdate falls on the same date of birth as the petitioner or respondent when the other party is to have custody. Because custody changes every other year, anomalies are not usually apparent. Anomalies occur with much more frequency than the courts, attorneys or anyone associated with family law is even aware of and place a great burden on police departments and other responding agencies, the court included which they may properly not even be aware of, violation of court orders not being study or data retained by the courts on the issue. However, police officers, as first responders are frequently tasked with the responsibility to respond to these calls for service, shouting matches, filing of police reports to deal with these issues to no one's satisfaction.

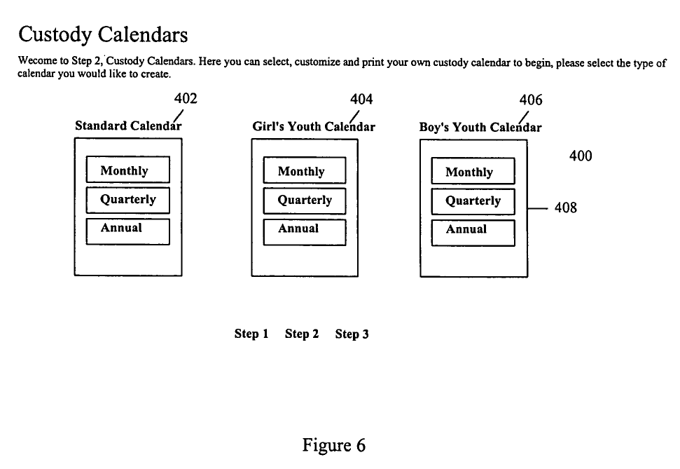

Referring to FIG. 6, the second module is the Custody Calendar 400 and provides for the creation of standard 402, girl's youth and boy's youth calendars 404, 406. The system generates monthly, quarterly and annual calendars 408.

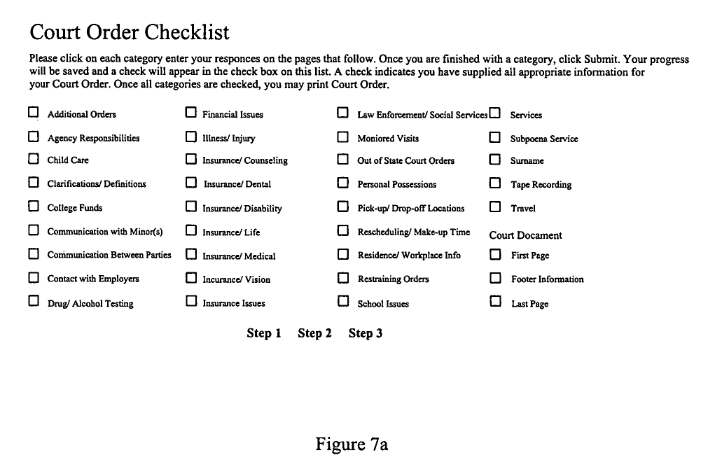

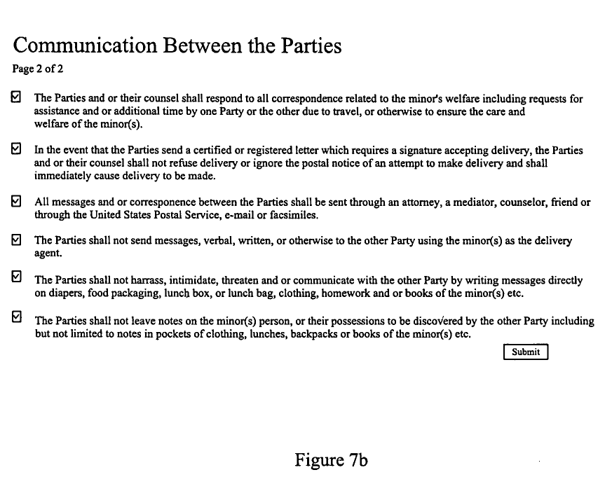

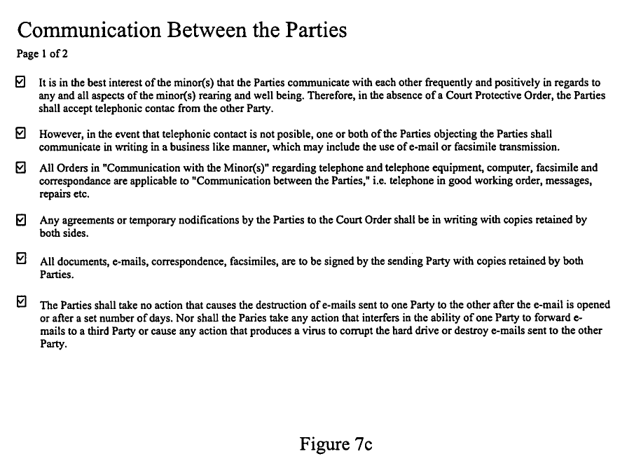

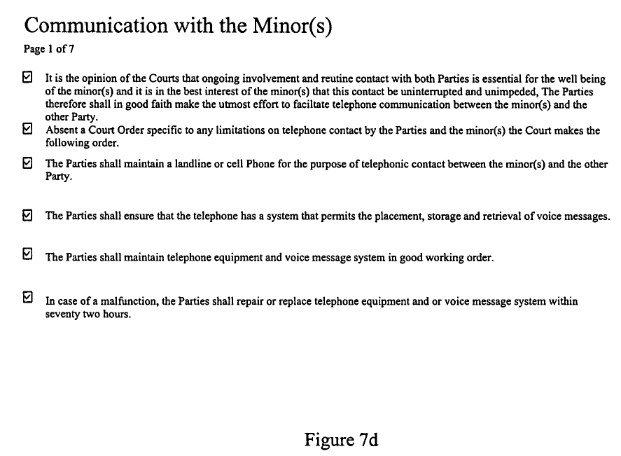

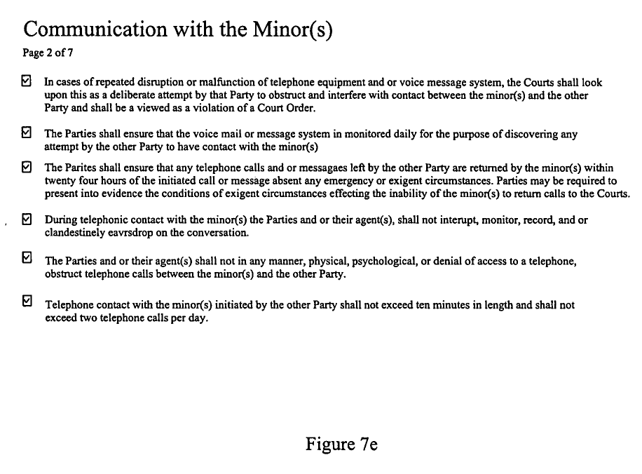

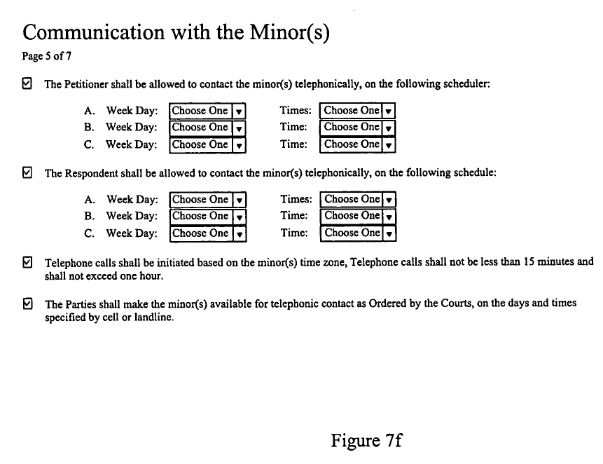

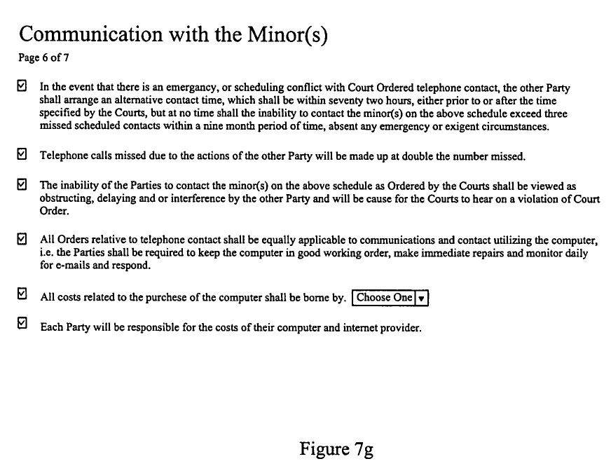

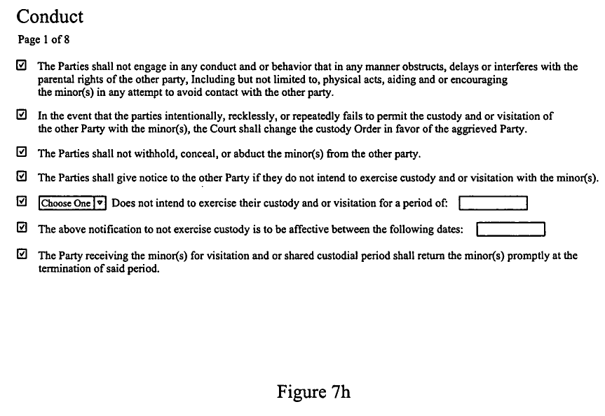

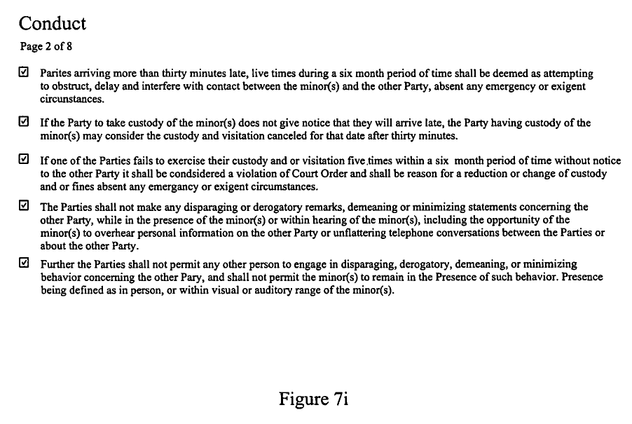

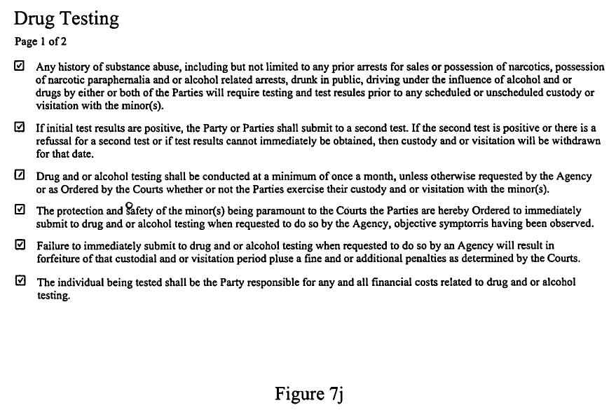

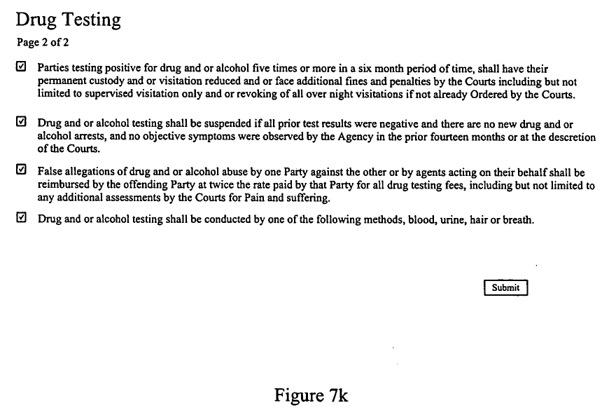

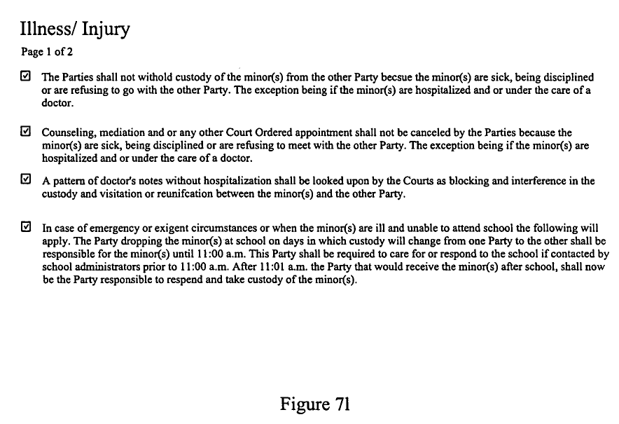

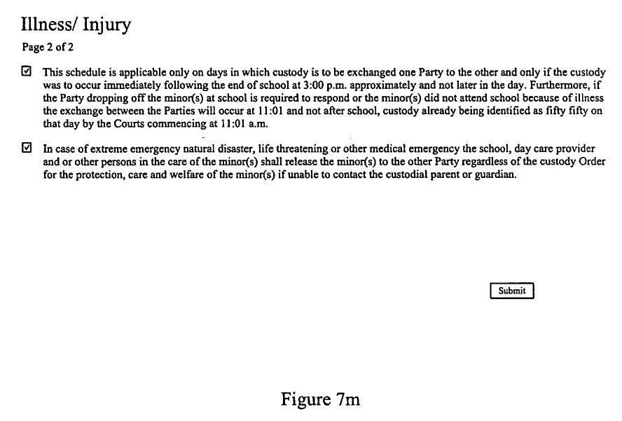

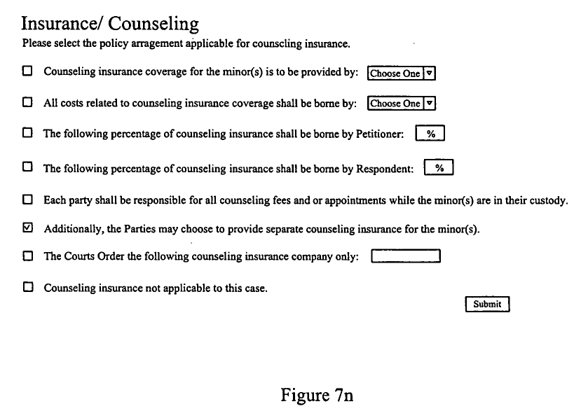

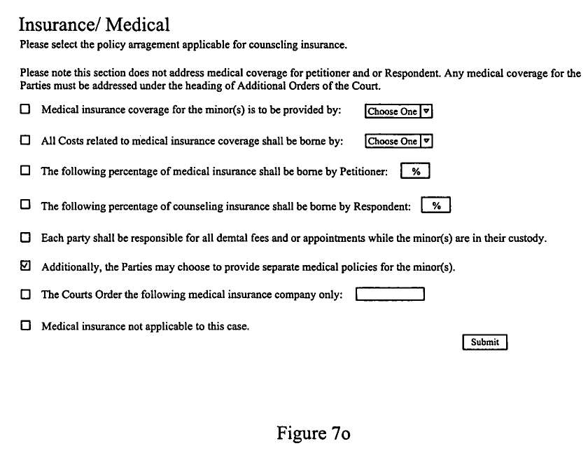

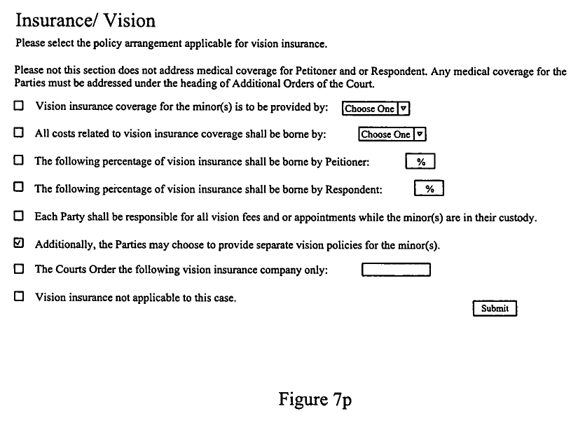

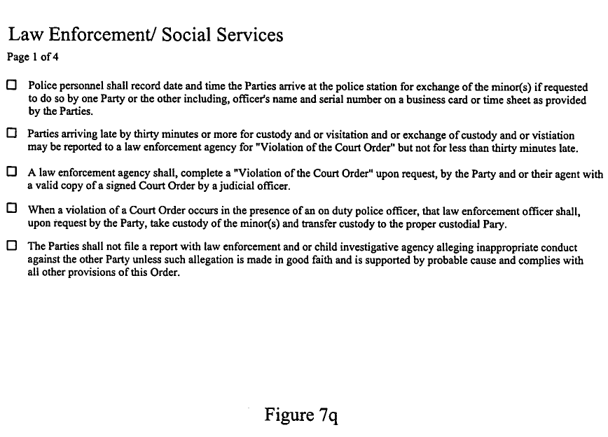

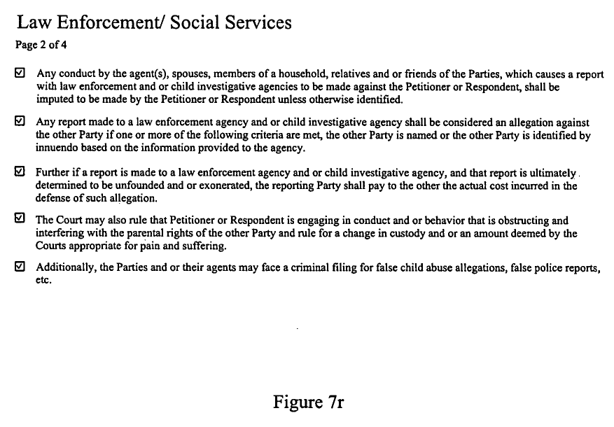

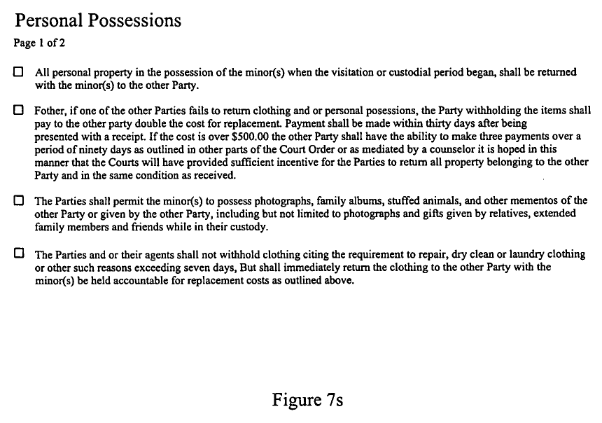

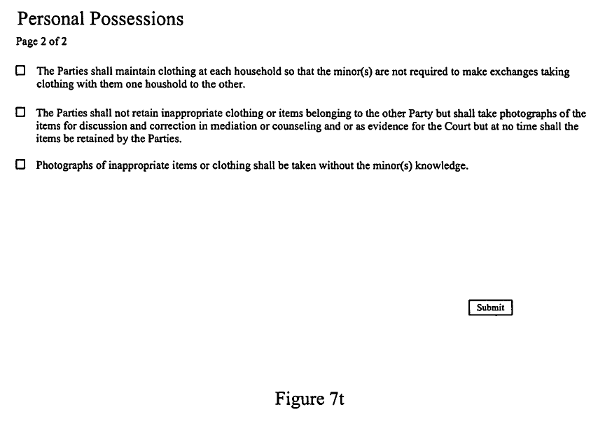

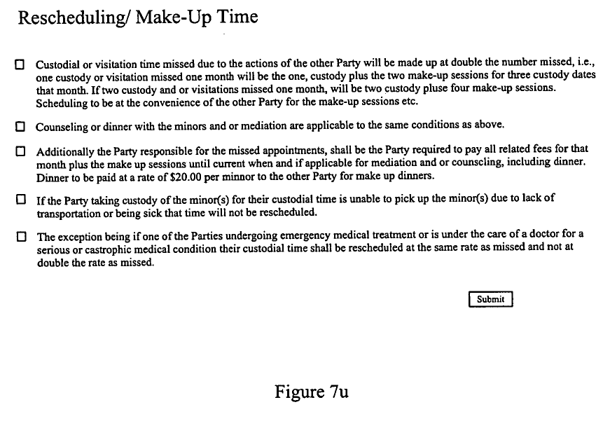

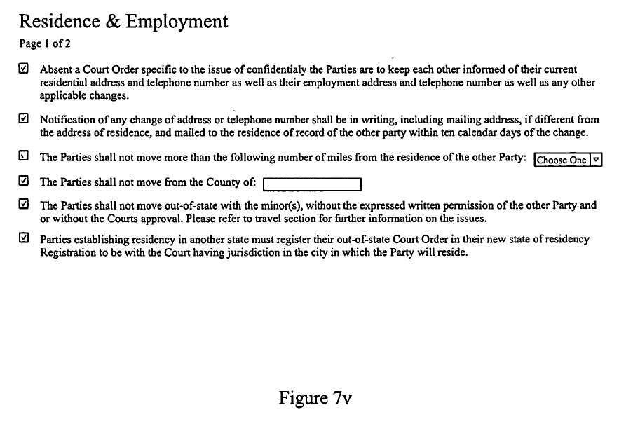

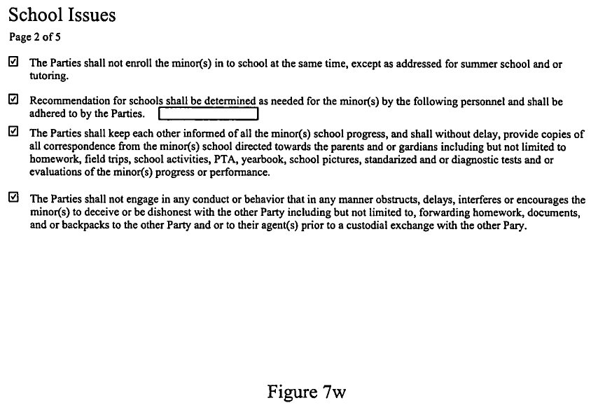

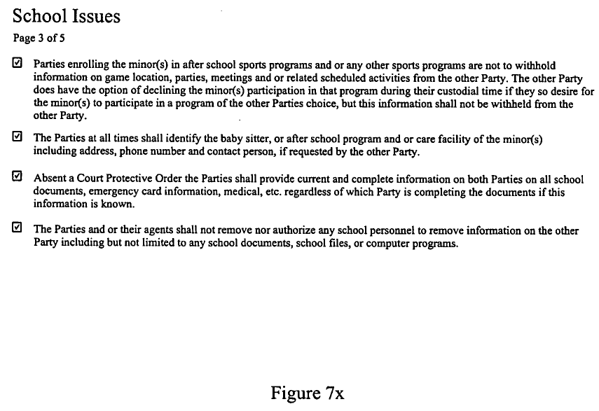

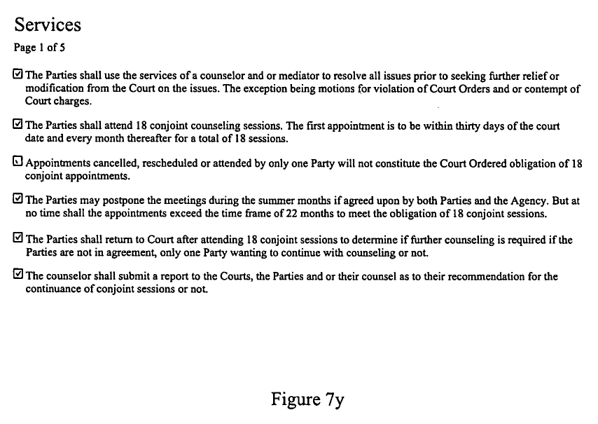

The final module contains a plurality of user screens for creating the Court Order and are set forth in FIGS. 7a to 7y. The purpose of this module is to provide a comprehensive series of information which is critical to the creation of the Court rder. This includes setting forth the responsibilities of the agency 500, child care 502, the creation of college funds 504, communication protocols between the parties 506, drug testing 508, a plurality of invoice issues 510, pick up/drop off locations 512, restraining orders 514, and travel 516. All of the information can be input into the system. The system can generate a variety of travel restrictions.

Two additional functions will cover spousal support, attorney fees, etc. and property, which will cover disbursement of the property, real estate, furniture, stocks etc.

There are five main functions of the invention. The issuance of date specific court orders based on the court's rulings, i.e. every other weekend, first and third weekend, etc. In addition to creating specific court orders, there will also be the ability to identify anomalies. The templates for court orders, custody, property and financial screens, if possible, and the issuance of the court order must be in multiple languages.

English for presentation to law enforcement, school administrators or any other applicable entity and a second language of the parties, if they are incapable of a thorough understanding of the English language or do not speak English at all. Additionally, I wonder if it is possible to even protect that language. Most court orders are difficult for the parties who much abide by them because they do not understand what is expected of them entirely due to the wording of the court order. I have even worked on that issue seeking to use language sufficient to meet the court's requirement with that needed to be understood by the parties.

The present invention has been described with reference to the above-detailed embodiment. The true nature and scope of the present invention is to be determined with reference to the claims appended hereto.

1. A method creating a custody order and calculation comprising:
inputting general background information relating to parents and child for whom custody is to be shared;
calculating a custody percentage between the respective parents based upon a plurality of criteria including scheduling anomalies;
generating a Court Order setting forth the terms of the custody between the parents; and
generating a custody calendar for the parents.

2. A method creating a custody order and custody calculation comprising:
inputting general background information relating to the parent and child for whom custody is to be shared;
calculating a custody percentage between the respective parents based upon a plurality of criteria;
generating a Court Order relating to; and
generating a custody calendar for the parents setting for the custody percentages.

3. The method of claim 2 wherein the Court Order and custody calendar are generated in at least two languages.

4. The method of claim 2 wherein the criteria include scheduling anomalies.

7. The method of claim 4 wherein the criteria include a school and holiday schedule.

8. A method creating a custody order and custody calculation comprising:
inputting general background information relating to the parent and child for whom custody is to be shared;
calculating a custody percentage between the respective parents based upon a plurality of criteria including scheduling anomalies;
generating a Court Order relating to custody including communication protocols between the parents; and
generating a custody calendar for the parents and court.
